(19) United States
(12) Patent Application Publication
(10) Pub. No.: US 2005/0079422 A1
(43) Pub. Date: Apr. 14, 2005

(54) Lithium secondary battery having PTC powder and manufacturing method thereof

(76) Inventors: Chang-Mo Ko, Gyeonggi-do (KR); Ju-Dam Kim, Seoul (KR); Anna Lee, Seoul (KR); Su-An Choi, Gyeonggi-do (KR); Jun-Ku Han, Seoul (KR); Jong-Hwan Lee, Gyeonggi-do (KR)

Correspondence Address: JONES DAY, 222 EAST 41ST ST, NEW YORK, NY, 10017, US

(21) Appl. No.: 10/958,018

(22) Filed: Oct. 4, 2004

(30) Foreign Application Priority Data
Oct. 10, 2003 (KR) 10-2003-70605
Sep. 24, 2004 (KR) 10-2004-77326

(51) Int. Cl. H01M 4/58; H01M 6/00

(52) U.S. Cl. 429/231.95; 29/623.1

(57) ABSTRACT

Disclosed is a lithium secondary battery with high stability and excellent performance, and its manufacturing method. The lithium secondary battery includes a positive electrode including a positive electrode active material, a conductive material and a binding material and a negative electrode including a negative electrode active material and a binding material, and PTC powder is contained in at least one of the positive electrode and the negative electrode. If the battery is overheated due to overcharge, the PTC powder contained in the positive electrode and/or the negative electrode abruptly increases electric resistance to break electric current, thereby preventing further increase of temperature and resultantly preventing fire or explosion. In addition, the conductive material is contained separately from the PTC powder, performance of the battery is not deteriorated in the normal operation.

### BACKGROUND OF THE INVENTION

1. Field of the Invention

The present invention relates to a lithium secondary battery and its manufacturing method, and more particularly to a lithium secondary battery with stability in preparation to misuse such as overcharge and its manufacturing method.

2. Description of the Related Art

Generally, mobile electronic products such as video camera, mobile phone and portable PC require light weight and intelligent functions. In addition, along with development of electric automobiles, many researches are progressed for batteries used as power source of such electronic products or electric automobiles. In particular, interests are focused on a secondary battery that allows repeated charging and discharging, and researches for electrodes and batteries with improved capacity density and specific energy are also under progress.

Among secondary batteries, a lithium ion battery developed in the early 1990's is now standing in the spotlight due to its advantages such as high operation voltage and far better energy density rather than conventional batteries such as Ni-MH battery, Ni—Cd battery and sulfuric acid-lead battery that use electrolytic solution. However, because of using organic electrolyte, the lithium ion battery has a danger of fire and explosion and its manufacturing process is complicated. Thus, stability is the first consideration in manufacturing the lithium ion battery, and the problem of fire and explosion caused by overcharge should be urgently solved.

Overcharge is very dangerous to batteries, and the lithium ion battery is not an exception. If the lithium ion battery is overcharged, lithium ions keep moving from positive electrode to negative electrode, and the moved lithium ions grow on the negative electrode surface to form dendrite of resin structure. This dendrite causes excessive current and overheating due to the short circuit of battery, and in serious cases becomes a factor of explosion or fire.

In addition, if the lithium ion battery is overcharged beyond the rated voltage, electrolyte starts being dissolved, and temperature may be raised up to a flash point. Meanwhile, in case that LiCoO₂ is used as positive electrode active material, LiCoO₂ is changed into more stable spinel structure at high temperature to generate extra oxygen, and this extra oxygen is moved to the electrolyte whose temperature reaches the flash point, thereby causing a fire or explosion.

In order to prevent the generation of heat due to overcharge, there have been proposed various methods: attaching a protective circuit, breaking current flow with the use of increasing inner pressure of the battery, adding an additive to the electrolyte, or the like. However, the protective circuit or the current breaking tool using inner pressure requires additional space and cost, which is against the current trend oriented to larger capacity of battery. In addition, the method of adding an additive to electrolyte, proposed in U.S. Pat. No. 6,074,776, Japanese patent publication No. 2000-215909 and No. 2001-15155 or the like, has problems that Joule heating is fluctuated due to current value at the charging stage and internal resistance of the battery, a heating restraining tool is not regularly operated at a proper time, troubles are issued in process, and performance is deteriorated while the battery is normally operated.

Meanwhile, in order to prevent overcharge in anther way, Japanese patent publication No. 2000-164206 suggests a method of disposing a conductive middle layer, which is changed into a high resistive element by overcharge, between a positive electrode current collector and an active material layer, but this method also has problems that processes and costs are increased. In addition, Japanese patent publication H10-64548 suggests a method of adding a cooling material with cooling capacity over 30 J/g to an electrode plate, but it is revealed in the actual overcharge experiment that it is not competent enough for absorbing large quantity of heat that is instantaneously generated.

Meanwhile, U.S. Pat. No. 6,346,345 suggests replacing a common conductive material of the electrode with a conductive material having PTC (Positive Temperature Coefficient) characteristics so that resistance of the electrode is abruptly increased at high temperature due to short circuit of the electrode to break electric current. However, this method has a problem that performance of the battery is remarkably deteriorated since resistance of the electrode is too high in the normal operation.

### SUMMARY OF THE INVENTION

The present invention is designed to solve the problems of the prior art, and therefore it is an object of the present invention to provide a lithium secondary battery capable of breaking electric current when temperature of the battery is raised up due to internal or external factors in order to prevent fire or explosion without causing deterioration of performance of the battery in the normal operation, and its manufacturing method.

In order to accomplish the above object, a lithium secondary battery according to the present invention includes PTC powder with PTC characteristic that electric resistance is increased as temperature rises in at least one of a positive electrode and a negative electrode. That is to say, a lithium secondary battery in one aspect of the invention has positive electrode, negative electrode and electrolyte, wherein the positive electrode comprises a positive electrode current collector; and a positive electrode material layer formed on the positive electrode current collector and including a positive electrode active material capable of occluding and emitting lithium ions, a conductive material, and a binding material for binding the positive electrode active material and the conductive material, wherein the negative electrode comprises a negative electrode current collector; and a negative electrode material layer formed on the negative electrode current collector and including a negative electrode active material capable of occluding and emitting lithium ions, and a binding material for binding the negative electrode current collector and the negative electrode active material, wherein at least one of the positive electrode material layer and the negative electrode material layer further includes PTC (Positive Temperature Coefficient) powder having PTC characteristic that electric resistance is increased as temperature rises.

Here, the positive electrode material layer or the negative electrode material layer may include the PTC powder as much as 0.1 to 10 wt %. In addition, it is also possible that both of the positive electrode material layer and the negative electrode material layer may include the PTC powder as much as 0.1 to 10 wt %.

At this time, the PTC powder is preferably crystalline polymer powder in which granular conductive fillers are dispersed, the crystalline polymer preferably has a melting point of 80 to 170° C. and crystallinity of 10 to 80%, and the conductive filler is preferably carbon black, carbon fiber, graphite flake, or metal flake.

In addition, the conductive material is preferably free from PTC characteristic that causes increase of electric resistance as temperature rises, and the conductive material preferably has a particle size of 200 μm or below. Moreover, the conductive material preferably has electric resistivity in the order of 10⁻⁵ (Ω·cm) at normal temperature, and the PTC powder preferably has electric resistivity of 0.05 to 10 Ω·cm at normal temperature.

Thus, the lithium secondary battery according to the present invention is free from danger of fire or explosion since electric current is broken due to the PTC powder whose electric resistance is abruptly increased as temperature is raised high at misuse such as overcharge without deteriorating performance of the battery by means of the conductive material with very low electric resistance in the normal operation.

In another aspect of the invention, there is also provided a method for manufacturing a lithium secondary battery, which includes preparing positive electrode slurry by dispersing a positive electrode active material capable of occluding and emitting lithium ions, a conductive material, and a binding material for binding the positive electrode active material and the conductive material in a solvent; preparing a positive electrode by coating and drying the positive electrode slurry on a positive electrode current collector; preparing negative electrode slurry by dispersing a negative electrode active material capable of occluding and emitting lithium ions and a binding material for binding the negative electrode active material in a solvent; preparing a negative electrode by coating and drying the negative electrode slurry on a negative electrode current collector; laminating the positive electrode and the negative electrode with a separator, which is an insulation film, interposed therebetween; and putting the positive electrode, the negative electrode and the separator, which are laminated, into a package, injecting electrolyte thereto, and then sealing the package, wherein at least one of the positive electrode slurry preparing step and the negative electrode slurry preparing step is conducted to include PTC powder with PTC characteristic that electric resistance is increased as temperature rises into the slurry.

In the positive electrode slurry preparing step or the negative electrode slurry preparing step, 0.1 to 10 wt % of PTC powder is included in the positive electrode slurry (that is to become appositive electrode material layer) or in the negative electrode slurry (that is to become a negative electrode material layer). In addition, it is also possible that both of the positive electrode slurry and the negative electrode slurry includes 0.1 to 10 wt % of PTC powder, respectively.

### BRIEF DESCRIPTION OF THE DRAWINGS

Other objects and aspects of the present invention will become apparent from the following description of embodiments with reference to the accompanying drawing in which:

FIG. 1 is a sectional view schematically showing a lithium secondary battery according to a preferred embodiment of the present invention;

FIG. 2 is a photograph, taken by a scanning electron microscope (SEM), showing a positive electrode of the lithium secondary battery containing PTC powder according to a preferred embodiment of the present invention;

FIG. 3 is a graph showing relative capacities of the lithium secondary battery according to the embodiment of the present invention and a lithium secondary battery according to a comparative example with respect to a discharge ratio; and

FIG. 4 is a graph showing resistance characteristics of the lithium secondary battery according to the embodiment of the present invention and the lithium secondary battery according to a comparative example with respect to temperature.

### DESCRIPTION OF THE PREFERRED EMBODIMENT

Hereinafter, embodiments are described for specifying the present invention, and detailed description will be provided with reference to the accompanying drawings for better understanding of the invention. However, the embodiments of the present invention may be modified in various ways, and it should not be interpreted that the scope of the invention is limited to the embodiments described below. The embodiments of the invention are provided just for clearer and more definite illustration to those having ordinary skill in the art. In the drawings, the same reference numeral designates the same element.

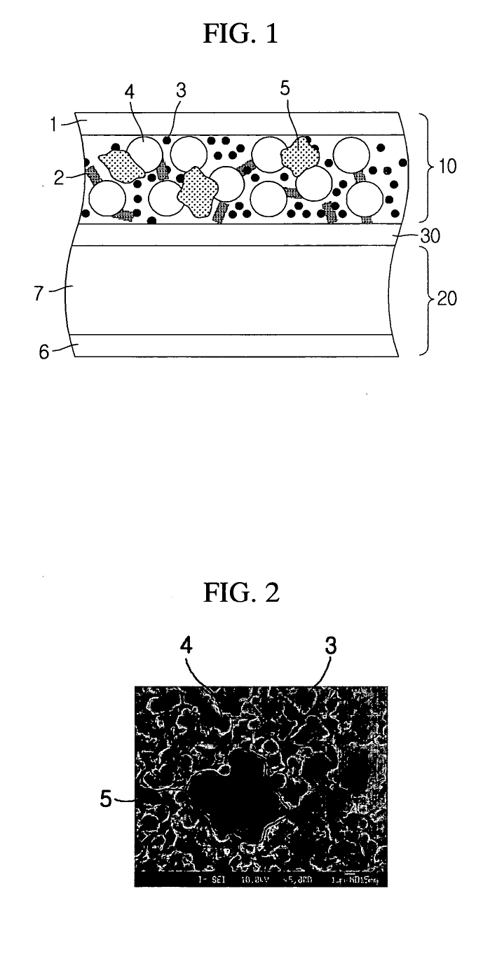

FIG. 1 is a sectional view schematically showing a lithium secondary battery according to a preferred embodiment of the present invention.

As shown in FIG. 1, the lithium secondary battery of this embodiment includes a positive electrode 10, a negative electrode 20, a separator 30, and electrolyte (not shown), in brief.

In the positive electrode 10, a positive electrode material layer including a positive electrode active material 4, a conductive material 3, PTC powder 5 and a binding material 2 is coated and compressed on a positive electrode current collector 1 made of a metal foil such as aluminum.

The positive electrode active material 4 is made of a material capable of occluding and emitting lithium ions during charging or discharging, and generally made of lithium-metal oxide such as LiCoO₂, LiMn₂O₄, LiMnO₂, LiNiO₂, LiNi₁₋ₓCoₓO₂ (0<x<1), and the like.

The conductive material 3 is preferably made of carbon black, and other materials such as metal powder or flake may also be used if they have good conductivity. Meanwhile, the conductive material 3 contains only conductive substances, so it does not have PTC (Positive Temperature Coefficient) characteristic, namely a characteristic that electric resistance is increased as temperature rises, differently from the PTC powder 5 described later. Thus, the conductive material 3 has very small size (e.g., 200 μm or less) and very low electric resistivity (e.g., in the order of 10⁻⁵ (Ω·cm)) regardless of temperature.

The PTC powder 5 is a factor to enhance stability of the lithium secondary battery according to the present invention. In the normal operation, the PTC powder 5 has electric resistivity of 0.05 to 10 Ω·cm to give relatively good conductivity at normal temperature, but the electric resistance is abruptly increased when temperature rises. The PTC powder 5 may be made of crystalline polymer powder in which granular conductive fillers are dispersed. The crystalline polymer is preferably a polymer such as polyethylene that has a melting point of 80 to 170° C. and crystallinity of 10 to 80%, and the granular conductive filler may use a conductive particle such as carbon black, carbon fiber, graphite flake and metal flake. Alternatively, the PTC powder 5 may be made of ceramic material such as BaTiO₃, or BaTiO₃ doped with Sr or Pb. Meanwhile, the PTC powder 5 preferably has a particle size of 0.1 to 50 μm. If the particle size is too small, making the powder is difficult and cost is increased, while, if the particle size is too great in comparison to thickness of the electrode, flatness is deteriorated.

Meanwhile, the positive electrode material layer preferably includes the PTC powder 5 as much as 0.1 to 10 wt %.

If a content of the PTC powder 5 included in the positive electrode material layer is less than 0.1 wt %, the abnormal current breaking function that prevents fire or explosion of the secondary battery when the temperature of the secondary battery is raised up due to internal or external factors is deteriorated. If the content is more than 10 wt %, resistance of the electrode is excessively increased in the normal operation of the secondary battery, and performance of the battery is deteriorated due to deficiency of the content of the active material.

The binding material 2 is an element for binding the positive electrode active material 4 and the conductive material 3 of the positive electrode material layer with each other, or binding them to the positive electrode current collector 1. The binding material 2 is made of a material such as PVDF (polyvinylidene fluoride).

On the other hand, the negative electrode 20 is formed by coating and compressing a negative electrode material layer 7 including a negative electrode active material and a binding material on a negative electrode current collector 6 made of a metal foil such as copper, similar to the positive electrode 10. The negative electrode active material is made of lithium metal or carbon material capable of occluding and emitting lithium ions, and the carbon material is somewhat advantageous in preventing formation of dendrite. Meanwhile, the binding material may use PVDF, identically to the binding material 2 of the positive electrode material layer.

The separator 30 is a film interposed between the positive electrode 10 and the negative electrode 20 in order to prevent them from being directly contacted to cause a short circuit. The separator 30 is made by one layer of polymer film such as polyethylene or polypropylene, or many layers of polymer films laminated.

Meanwhile, a unit cell composed of the positive electrode 10, the separator 30 and the negative electrode 20, or a cell in which such unit cells are laminated with the separator interposed therebetween, is sealed by a package (not shown), and electrolyte (not shown) is injected in the sealed package.

The electrolyte is an element for mediating movement of materials so that oxidation and deoxidation reactions occurring in the positive electrode 10 and the negative electrode 20 are harmonized. The electrolyte includes organic electrolyte or solid polymer electrolyte that contains lithium salt. As for the lithium salt, LiPF₆ is advantageous to prevent formation of dendrite.

In the lithium secondary battery configured as above according to this embodiment, if temperature of the battery is raised due to overcharge or excess current caused by a short circuit, electric resistance of the PTC powder 5 in the aforementioned positive electrode material layer is abruptly increased to break electric current. In case that the PTC powder 5 is made by dispersing conductive fillers in a crystalline polymer, the crystals starts being melted as the temperature rises beyond a melting point, thereby abruptly increasing the electric resistance. Meanwhile, while the battery is normally operated, the conductive material 3 with very low electric resistance ensures flow of the electric current, so adding the PTC powder does not deteriorate performance of the battery in the normal operation.

Meanwhile, though it is depicted and described that the PTC powder 5 is contained only in the positive electrode 10, PTC powder may be included in the negative electrode 20 instead of the positive electrode 10, or in both of the positive electrode 10 and the negative electrode 20, of course.

In addition, though it is depicted and described that the active material is coated only on one surface of the positive electrode current collector 1 and the negative electrode current collector 2, the active material may be coated on both surfaces thereof, if necessary.

Now, a method for manufacturing the lithium secondary battery according to this embodiment is described.

First, the positive electrode 10 is formed as follows. An aluminum foil is prepared as a positive electrode current collector 1, and a positive electrode material layer is formed thereon. As for the positive electrode material layer, the positive electrode active material, the conductive material, the PTC powder and the binding material, which are already mentioned above, are dispersed and mixed in an organic solvent (e.g., NMP (N-methylpyrrolidone)) to make positive electrode slurry. This positive electrode slurry is coated on the aluminum foil that is a positive electrode current collector, and then dried and compressed by heat to make a positive electrode 10.

Meanwhile, the PTC powder 5 is prepared by dispersing fillers such as carbon black, carbon fiber, graphite flake or metal flake into a crystalline polymer such as polyethylene, then crosslinking them by ultraviolet ray irradiation or heating, and then curing and pulverizing them, or ceramic material powder such as BaTiO₃, or BiTiO₃ doped with Sr or Pb may also be prepared.

The negative electrode 10 is also made by coating, drying and compressing the negative electrode slurry, which is prepared by dispersing the negative electrode active material and the binding material in an organic solvent, on the negative electrode current collector made of copper foil.

Subsequently, the positive electrode 10 and the negative electrode 20 are laminated with the separator 30 interposed therebetween. At this time, if necessary, the separator 30 is adhered to the positive electrode 10 and the negative electrode 20 by means of adhesive, and this laminating process may be repeated several times to make a battery with larger capacity.

The positive electrode 10, the negative electrode 20 and the separator 30 that are laminated as above are put into a package, which may have various shapes such as a coin shape, a cylindrical shape and a pack shape, and electrolyte is injected into the package. The package is then sealed to make an end cell of a lithium secondary battery with a desired shape.

Meanwhile, as described above, the PTC powder 5 may be contained in the negative electrode 20 as well as in the positive electrode 10. In this case, what is needed is just adding PTC powder into the negative electrode slurry while it is being prepared.

The following experiments were conducted to compare performance of the lithium secondary battery of the present invention with that of a conventional one.

Embodiment 1

LiCoO2, carbon black, PVDF and polyethylene in which carbon black is dispersed, respectively used as the positive electrode active material, the conductive material, the binding material and the PTC powder, were dispersed in NMP at the ratio of 94:3:2:1 by weight to make slurry. This slurry was coated on an aluminum foil that is a positive electrode current collector, and it was sufficiently dried at 150° C. and then compressed to make a positive electrode. After compression, the positive electrode material except the aluminum foil had a thickness of 70 μm.

A lithium metal was used for the negative electrode, a laminated layer of polyethylene and polypropylene (E157 of Cellguard Co.) was used for the separator, and a liquid electrolyte in which LiPF₆ of 1M concentration was contained in a solvent where ethylene chloride, propylene chloride and diethyl chloride were mixed at the ratio of 3:2:5 by weight was used for the electrolyte. The completed battery was a coin cell with a coin shape.

Embodiment 2

A coin cell was made in the same way as the embodiment 1, except that a ratio of the positive electrode active material, the conductive material, the binding material and the PTC powder was 93:1:3:3 by weight.

### COMPARATIVE EXAMPLE 1

A coil cell was made in the same way as the embodiment 1, but PTC powder was not included in order to comparatively check influence of the PTC powder. That is to say, a ratio of the positive electrode active material, the conductive material, the binding material and the PTC powder was 94:3:3:0 by weight.

### COMPARATIVE EXAMPLE 2

A coil cell was made in the same way as the embodiment 1, but a conductive material was not included in order to comparatively check influence of the conductive material. That is to say, a ratio of the positive electrode active material, the conductive material, the binding material and the PTC powder was 94:0:3:4 by weight.

FIG. 2 is a photograph, taken by a scanning electronic microscope, showing the positive electrode material layer of the embodiment 1 as described above. As seen in the photograph, it is found that there are the positive electrode active material 4, the conductive material 3 and the PTC powder 5.

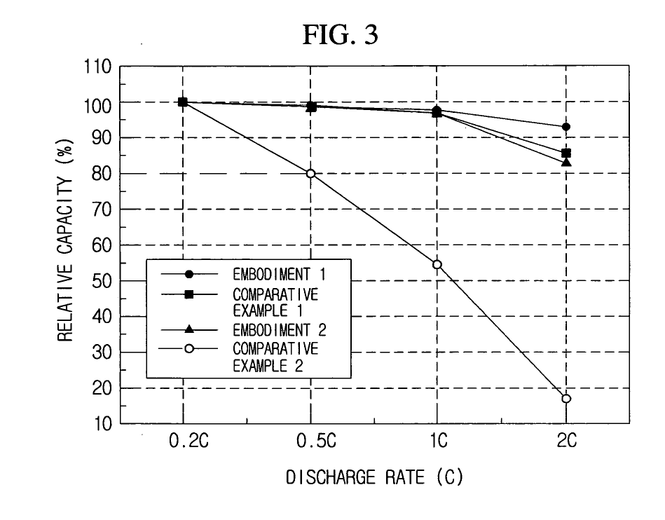

FIG. 3 is a graph showing a relative capacity of each coin cell made as mentioned above with respect to a discharge rate (C-rate). The relative capacity is defined as a capacity at each discharge rate, compared with a capacity when a discharge rate is 0.2C that is set to 100%. As understood from the graph of FIG. 3, there is no problem in the cell containing the PTC powder and the conductive material (made in the embodiments 1 and 2) and in the cell containing at least the conductive material (made in the comparative example 1), but the cell not containing conductive material (made in the comparative example 2) shows performance seriously deteriorated.

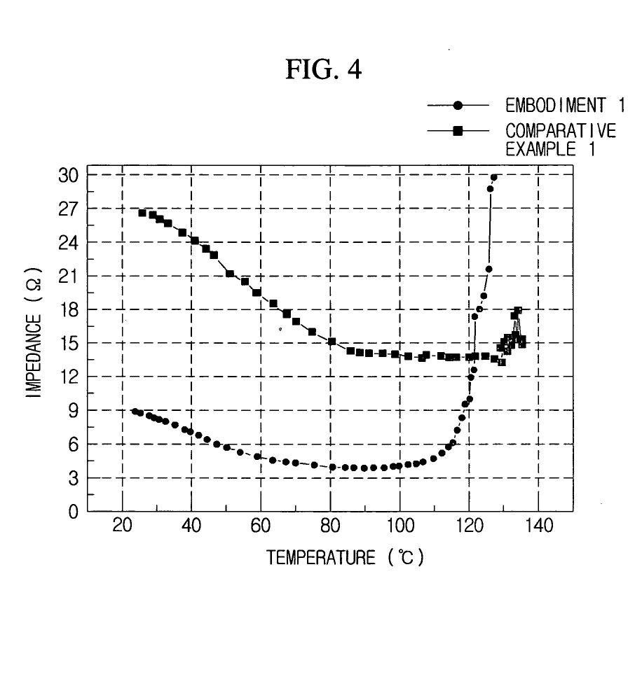

FIG. 4 is a graph showing a change of electric resistance as temperature rises as for the cell made in the embodiment 1 (or, a cell containing the PTC powder and the conductive material) and the cell made in the comparative example 1 (or, a cell not containing PTC powder). As understood from the graph of FIG. 4, electric resistance is abruptly increased in the cell of the embodiment 1 when temperature rises beyond 120° C., while there is substantially no increase of electric resistance in the cell of the comparative example 1. This means that, when temperature is increased due to overcharge or short circuit of the battery, the cell of the embodiment 1 may break electric current to prevent further increase of temperature and also prevent resultant fire or explosion, while the cell of the comparative example 1 does not hinder the continuous increase of temperature with leaving possibility of fire or explosion.

Synthesizing the experiment results, it may be found that the lithium secondary battery of the present invention is able to prevent deterioration of battery performance by means of the conductive material without PTC characteristic together with ensuring high stability owing to the PTC powder.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### Applicability to the Industry

As described above, by containing PTC powder into at lest one of the positive electrode including positive electrode active material, conductive material and binding material and the negative electrode including negative electrode active material and binding material, the lithium secondary battery of the present invention may prevent increase of temperature beyond a certain level and fire or explosion of the battery since resistance is abruptly increased to break electric current when the battery is overheated by overcharge. In addition, since the lithium secondary battery of the present invention contains conductive material separately from the PTC powder, performance of the battery is not deteriorated in the normal operation.

Meanwhile, the lithium secondary battery of the present invention may be manufactured by just adding PTC powder while the positive electrode or the negative electrode is made. Thus, the lithium secondary battery with high stability and excellent performance may be manufactured without any special problem.

1. A lithium secondary battery having positive electrode, negative electrode and electrolyte,
wherein the positive electrode comprises:
a positive electrode current collector; and
a positive electrode material layer formed on the positive electrode current collector and including a positive electrode active material capable of occluding and emitting lithium ions, a conductive material, and a binding material for binding the positive electrode active material and the conductive material,
wherein the negative electrode comprises:
a negative electrode current collector; and
a negative electrode material layer formed on the negative electrode current collector and including a negative electrode active material capable of occluding and emitting lithium ions, and a binding material for binding the negative electrode current collector and the negative electrode active material,
wherein at least one of the positive electrode material layer and the negative electrode material layer further includes PTC (Positive Temperature Coefficient) powder having PTC characteristic that electric resistance is increased as temperature rises.

2. The lithium secondary battery according to claim 1,
wherein the positive electrode material layer includes the PTC powder as much as 0.1 to 10 wt %.

3. The lithium secondary battery according to claim 1,
wherein the negative electrode material layer includes the PTC powder as much as 0.1 to 10 wt %.

4. The lithium secondary battery according to claim 1,
wherein the PTC powder is crystalline polymer powder in which granular conductive fillers are dispersed.

5. The lithium secondary battery according to claim 4,
wherein the crystalline polymer has a melting point of 80 to 170° C. and crystallinity of 10 to 80%.

6. The lithium secondary battery according to claim 4,
wherein the conductive filler is at least one selected from the group consisting of carbon black, carbon fiber, graphite flake, and metal flake.

7. The lithium secondary battery according to claim 1,
wherein the PTC powder is powder of BaTiO₃, or BaTiO₃ doped with Sr or Pb.

8. The lithium secondary battery according to claim 1,
wherein the conductive material is free from PTC characteristic that causes increase of electric resistance as temperature rises.

9. The lithium secondary battery according to claim 1,
wherein the conductive material has a particle size of 200 μm or below.

10. The lithium secondary battery according to claim 1,
wherein the conductive material has electric resistivity in the order of 10⁻⁵ (Ω·cm) at normal temperature, and the PTC powder has electric resistivity of 0.5 to 10 Ω·cm at normal temperature.

11. The lithium secondary battery according to claim 1,
wherein the positive electrode and the negative electrode are laminated with a separator, which is an insulation film, interposed therebetween.

12. A method for manufacturing a lithium secondary battery, comprising:
preparing positive electrode slurry by dispersing a positive electrode active material capable of occluding and emitting lithium ions, a conductive material, and a binding material for binding the positive electrode active material and the conductive material in a solvent;
preparing a positive electrode by coating and drying the positive electrode slurry on a positive electrode current collector;
preparing negative electrode slurry by dispersing a negative electrode active material capable of occluding and emitting lithium ions and a binding material for binding the negative electrode active material in a solvent;
preparing a negative electrode by coating and drying the negative electrode slurry on a negative electrode current collector;
laminating the positive electrode and the negative electrode with a separator, which is an insulation film, interposed therebetween; and
putting the positive electrode, the negative electrode and the separator, which are laminated, into a package, injecting electrolyte thereto, and then sealing the package,
wherein at least one of the positive electrode slurry preparing step and the negative electrode slurry preparing step is conducted to include PTC powder with PTC characteristic that electric resistance is increased as temperature rises into the slurry.

13. The method for manufacturing a lithium secondary battery according to claim 12,
wherein, in the positive electrode slurry preparing step, 0.1 to 10 wt % of PTC powder is included in the positive electrode slurry.

14. The method for manufacturing a lithium secondary battery according to claim 12,
wherein, in the negative electrode slurry preparing step, 0.1 to 10 wt % of PTC powder is included in the negative electrode slurry.

15. The method for manufacturing a lithium secondary battery according to claim 12,
wherein the PTC powder is prepared by pulverizing crystalline polymer in which granular conductive fillers are dispersed.

16. The method for manufacturing a lithium secondary battery according to claim 15,
wherein the crystalline polymer has a melting point of 80 to 170° C. and crystallinity of 10 to 80%.

17. The method for manufacturing a lithium secondary battery according to claim 15,
wherein the conductive filler is at least one selected from the group consisting of carbon black, carbon fiber, graphite flake, and metal flake.

18. The method for manufacturing a lithium secondary battery according to claim 12,
wherein the PTC powder is powder of BaTiO₃, or BaTiO₃ doped with Sr or Pb.

19. The method for manufacturing a lithium secondary battery according to claim 12,
wherein, in the positive electrode slurry preparing step, the conductive material is free from PTC characteristic that causes increase of electric resistance as temperature rises.
